(19) United States
(12) Patent Application Publication
(10) Pub. No.: US 2007/0235292 A1
(43) Pub. Date: Oct. 11, 2007

(54) Foldable Conveyor Belt and System for Separating Material

(76) Inventor: Scott Messenger, Penola (AU)

Correspondence Address: Ralf C Francis;Francis Law Group, 1942 Embarcadero, Oakland, CA, 94606, US

(21) Appl. No.: 10/557,854

(22) PCT Filed: May 24, 2004
(86) PCT No.: PCT/AU04/00687

§ 371 Date: Feb. 15, 2007

(30) Foreign Application Priority Data
May 22, 2003 (AU) 2003902499

(51) Int. Cl. B65G 17/02

(52) U.S. Cl. 198/819; 198/818

(57) ABSTRACT

A foldable conveyor belt used in an apparatus, such as a grape harvesting machine, whereby the belt separates different dimensions material such as grapes form the pedicles. The belt includes a series of aligned projections along a base and defining a channel pattern, each projection having a free end, the projections supporting the grapes and the pedicles to be separated. For the cleaning of grapes and pedicles the width of the channel pattern is greater than the pedicles but smaller than the grapes. The belt is then folded longitudinally and inwardly causing the projections to capture the pedicles or part extending in the channels. As the pedicles are captured the belt is inverted causing only the grapes to fall away, typically to another belt. The belt is then unfolded but is still inverted causing the now free pedicles to drop onto yet another belt. Thus the grapes and the pedicles are efficiently separated.

This invention relates to a device for separating material of different dimensions.

In particular this invention relates to a conveyor belt adapted to form part of a conveyor system used in fruit harvesters, such as grape harvesters, to separate the fruit from unwanted matter such as grapes from pedicles.

### BACKGROUND OF THE INVENTION

Conventionally a conveyor belt, as part of a conveyor system, is used to handle material for the transportation between points of processing in a manufacturing, harvesting or the like environment.

A problem with such a conventional belt is that the material being transported between these processing points may include unwanted matter. This then requires the unwanted mater to be removed before further processing may take place.

One way of addressing this problem of separating material to be of a more uniformed dimension before further processing, is to place slits or apertures along the conveyor belt. When the conveyor belt picks up a range of materials of different sizes anything smaller than the size of the slits or apertures will be sieved through the slits or apertures of the belt. The larger sized material will continue to be carried by the belt.

A first problem with separating the material from the conveyor belt by this method is that further apparatus and structural means will be required to receive that material being sieved through the conveyor belt. If no additional features are put in place within the conveyor system, it is likely that the conveyor belt will become clogged or inadvertently damaged, thereby reducing the possibility of transporting the required material to the next processing station. Hence, those conventional conveyor belts that include slits or apertures or the like, in order to separate one material from another during the transportation stage between processing stations, will also require additional design work to be introduced into the conveyor system besides a single belt. The single belt of such a conventional conveyor system, with or without the slits and apertures, is not capable of both transporting and separating material simultaneously while being carried thereon the belt. These conventional arrangements require not only a belt for transporting the material for further processing, but also an additional belt or alternative material handling apparatus, external to the transportation belt, to receive and then transport material that has been separated. If the separation of the material has not been completed by the time the belt reaches a subsequent processing station, it is likely that the material to be processed will not be uniform, so potentially such material could contaminate or at least provide for a product of poorer quality.

A further problem of belts of this design is that at times, the material that is being handled may include different types of materials whose shape is also quite different. A prime example of this is in grape harvesters where the fruit, typically round, is of a significantly different shape to pedicles that although of a much smaller circular cross-section are quite long and unlikely to fall through slits or apertures.

It is therefore an object of the present invention, to provide a conveyor belt for a conveyor system, capable of both transporting and separating material carried thereon between processing station without additional external features.

It is a further object of this invention is to overcome, or at least substantially ameliorate some of the disadvantages and shortcomings of conventional conveyor belts and conveyor systems discussed above, or alternatively, at least provide the public with an improved conveyor belt that is adapted to be used within a conveyor system for handling material.

It is a still further object of the present invention to provide for a conveyor system to be used with fruit harvesters, such as a grape harvester, that can separate the fruit from pedicles.

### SUMMARY OF THE INVENTION

Therefore, in one form of the invention there is proposed a foldable conveyor belt mountable to a conveyor system framework for separating a first from a second material, said second material having at least one dimension smaller than said first material, said belt including;

a base and a series of aligned projections extending along said base, each projection having a free end and adapted to support on top therein said first and second material;

a channel network between said projections of a width equal at least to said one smaller dimension of said second material and smaller than the dimension of said first material to receive at least a portion of only said second material;

whereby said belt is adapted to be inwardly folded when both first and second material is carried thereon, causing corresponding apexes between adjacent aligned projections to approach each other thereby capturing said portion of said second material located within said channel network whilst still freely supporting said first material.

In preference said projections are characterised by being a series of selectively spaced bristles

An advantage of such an arrangement is that the belt is inherently adapted to both transport and separate material that it carries. Material of a larger dimension is supported on the free end or tips of the projections or bristles, while the spacing between aligned bristles forms a network of meshed or pattern channels, capable of receiving material having at least one dimension less than that of the spacing between such bristles. An example as applied to the present invention is of separating harvested grapes from pedicles. The grapes are typically of a circular or elliptical cross-sectional shape and provided that the spacing between the bristles is smaller than the smallest cross-section of the grapes, the grapes are supported on top of the projections. On the other hand, pedicles are thin and long bits of plant matter and although the whole pedicle would typically not fall into the channels defined by the bristle spacings at least some portion of it would. Once the belt is folded and the ends of the bristles effectively brought together, the pedicles are captured much like using a persons fingers. With one material captured, i.e. the pedicles, and the other, the grapes, being free, simple inversion of the belt leads to a separation of the two. Of course, some grapes may be quite small and some plant matter quite larges, but overall the present design will lead to a high percentage cleaning rate.

In preference the belt is folded around its longitudinal axis until the free ends of adjacent transverse bristles abut each other.

The bristles then form a substantial crisscross arrangement. The crisscross between aligned bristles configures an apex between adjacent bristles. These apexes provide the physical or mechanical means to separate that first material supported on the free ends of the bristles, with the second material, or part of it, captured by the apexes.

A still further advantage of such an arrangement is that the foldable belt requires no external additional features or design to be incorporated into the conveyor system or the belt, so as to carry out the separating of the first and second material during transportation of the material between various processing stations. The bristles that are an inherent characteristic of the conveyor belt provides the means for separating the first and second material, and once the conveyor belt is folded the configuration of the crisscross arrangement between adjacent bristles to form the apexes, then provides for the physical separation between the first and second material.

In a further form of the invention there is proposed a conveyor belt assembly including a foldable belt as claimed in any one of the above claims and further including a folding means adapted to cause said belt to be folded inwardly along its longitudinal axis.

In preference said folding means includes a longitudinally arced segment through which is fed said belt such that when the belt is drawn through the segment, the belt folds inwardly into a corresponding arc shape.

An advantage of such an arrangement is that the arc shaped segment of the conveyor framework provides structural means for the folding of the conveyor belt inwards along the belts longitudinal axis. As the belt folds into the arc shape according to the structural feature of the framework, the adjacent bristles on the belt incline inwards so as to abut and to form the apexes that are capable of capturing said second material.

In preference said assembly includes two spatially separated rollers around which is fed said belt, the first of said rollers being in a generally horizontal orientation, the second roller being at an angle substantially different from the horizontal.

In preference said second roller inverts the belt through an angle greater than some 120 degrees thereby causing the first material to fall away from said belt.

Preferably said belt assembly includes at least three operable sections through which the belt is inverted, the first section adapted to enable for the feeding of said first and second material, the second section defined by the arc segment causing said belt to inwardly fold capturing said second material and causing said first to fall away and the third section during which said belt unfolds causing said second material to fall away from said belt as it is fully inverted.

In preference the length of the three sections is approximately equal.

In preference said assembly further includes a second belt adapted to convey said separated first material away from said conveyor belt.

In preference said assembly further includes a third belt adapted to convey away said separated second material.

In a further from of the invention there is proposed a grape harvesting machine utilising a material separation belt as defined above.

Thus as the conveyor belt is drawn through the assembly and is rotated the first material, such as grapes falls away from the belt due to gravity whilst the second is held captive. With the unfolding and further rotation of the belt, the second material also falls due to gravity. Each separate section may have a separate material handling system thus causing the two materials to be separated.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a perspective view of a section of the conveyor belt embodying the present invention and in an unfolded configuration;

FIG. 2 is a cross-sectional view of the belt;

FIG. 3 is a perspective view of the belt with the belt partially folded along its longitudinal axis;

FIG. 4 is a cross-sectional view of the folded belt of FIG. 3;

FIG. 5 is a perspective view of the belt when substantially folded along its longitudinal axis;

FIG. 6 is a cross-sectional view of the belt of FIG. 5;

FIG. 7 is a perspective view of the belt when mounted in a material cleaning system;

FIG. 8 is a schematic perspective view of the belt of FIG. 7 when in an operating mode;

FIG. 9 is a cross-sectional view along 9-9′ of FIG. 8;

FIG. 10 illustrates the use of the present invention when applied to a grape harvester; and

FIG. 11 illustrates an alternate configuration of the belt bristles.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

The following description will describe a preferred embodiment of the invention when used to separate harvested grapes from pedicles and other matter. However, it is to be understood that the present invention may equally well be employed to separate not only other fruits from pedicels and the like, but also materials of different dimensions. The reader should therefore be aware that although the following description is limited to the separation of grapes from pedicles it is not meant to limit the invention to this application.

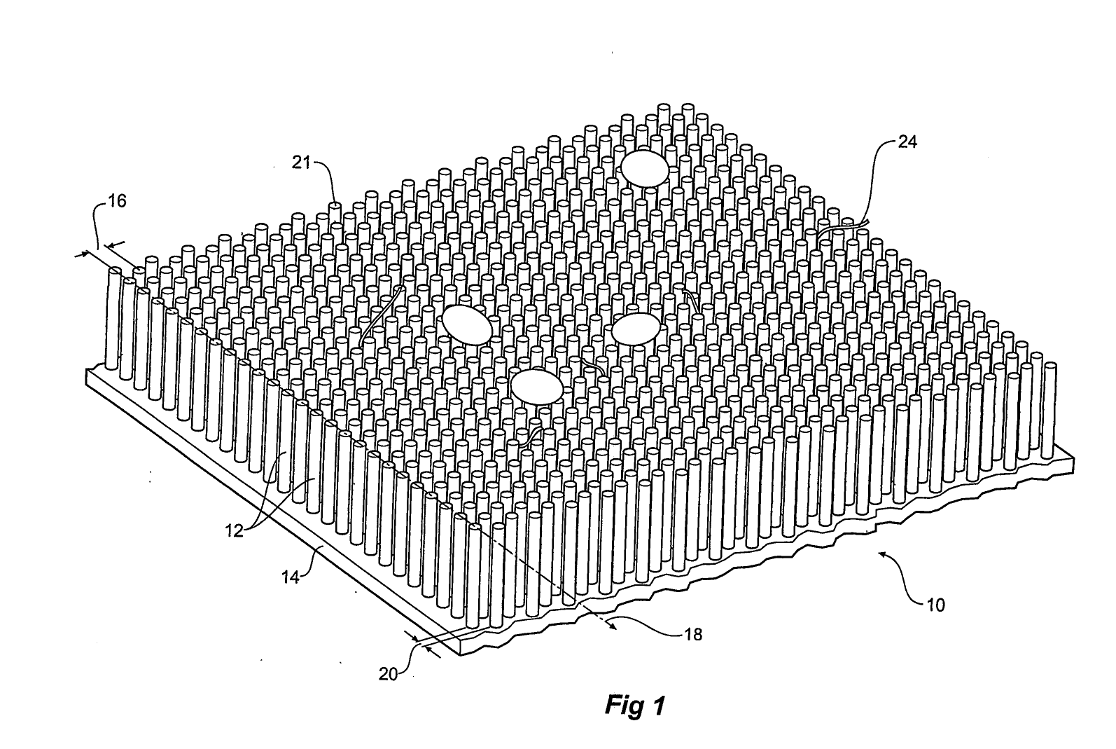

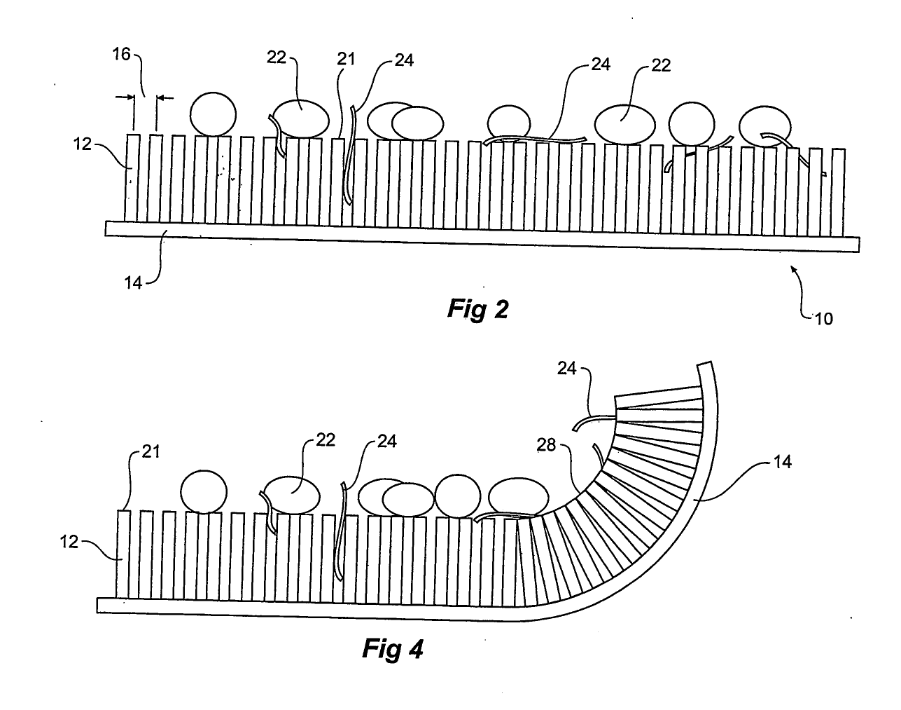

Referring now to FIGS. 1 and 2 there is shown a section of the belt employed in the present invention. The belt 10 includes a series of spaced apart bristles or projections 12. The bristles 12 extend generally upwardly from a base 14 along the length and the width of the belt 10. The spacing 16 between adjacent bristles 12 is selected according to the dimensions of the material that is to be separated once transported and carried along the conveyor belt 10. Accordingly in the present case, the spacing or gap 16 between the bristles 12 is selected to be some 6 mm, so that a central bristle will have other bristles located around it in circular arrangement at a distance of some 6 mm. This geometry results in multiple longitudinal rows 18 of bristles along the length of the belt, with each adjacent row shifted to the other in the longitudinal direction 20 by 6 mm. The top 21 of the bristles is generally a flat surface, the bristles being of a circular configuration of a diameter equal to their spacing, that is, approximately 6 mm. The height of the bristles for when used for grape harvesting has been chosen to be some 40 mm, the thickness of the base some 6 mm, both being constructed from rubber or rubber type flexible material enabling both the belt as a whole to be bent as well as individual bristles.

The belt in operation is configured to carry on top of the bristles 12 harvested material including grapes 22 and pedicles 24. Pedicles are the long and thin plant material from the grape vines that are also collected during grape harvesting. Being of such a configuration, it is inevitable that when placed on the belt 10, at least some portion of most pedicles will fall or extend into the spacing 16 between the bristles 12.

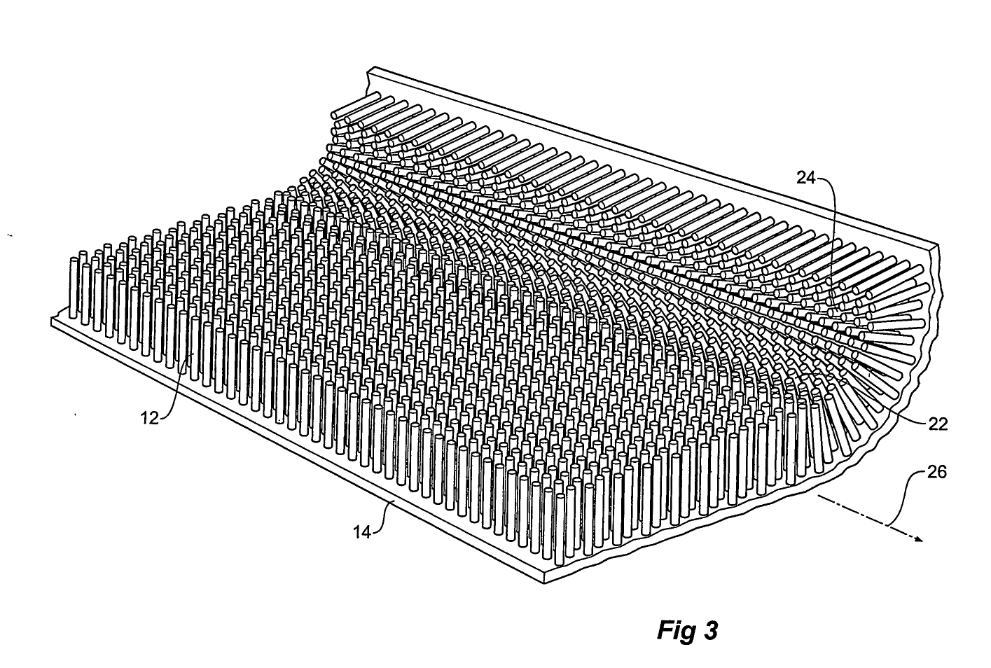

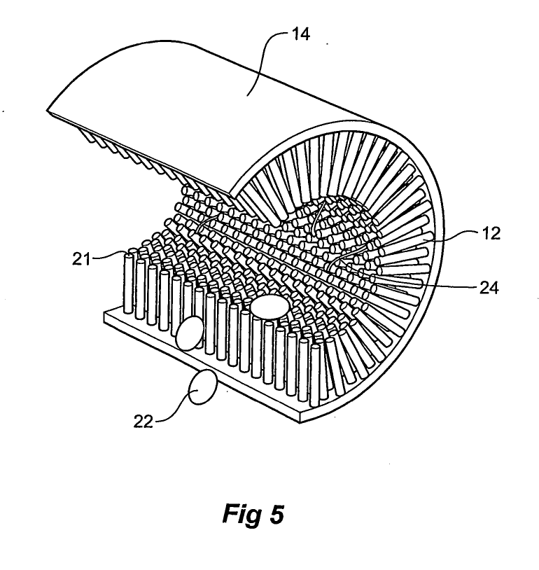

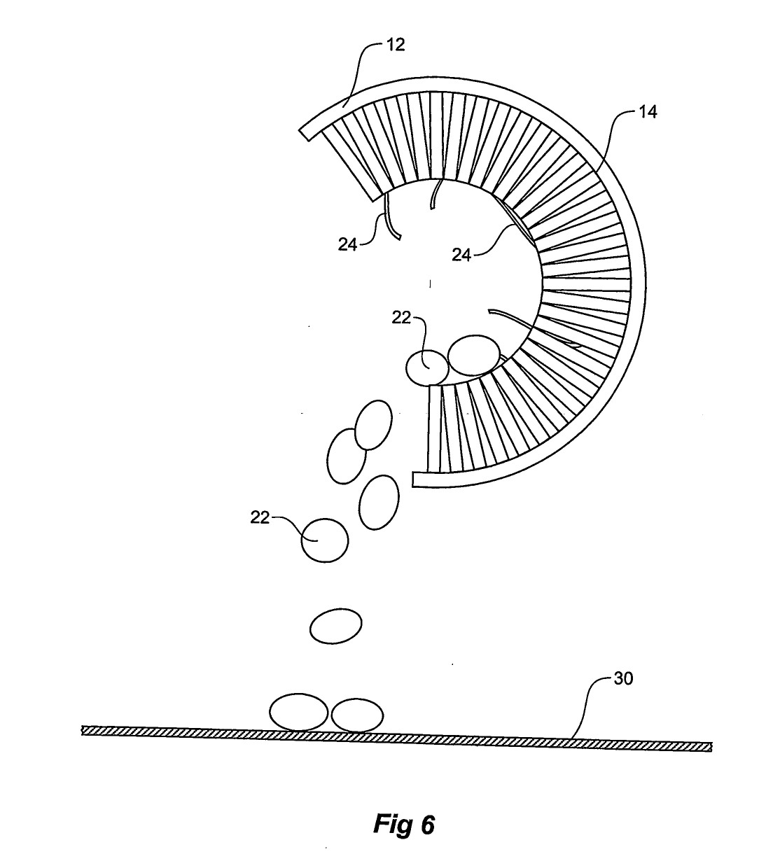

Illustrated in FIGS. 3 to 6 are the advantages of the configuration of the present belt. When the belt 10 is folded inwardly about its longitudinal axis 26 it causes the spacing 16 at the free end of the bristles 12 to be reduced to the point where the tops or apexes of the bristles may even be touching (28 and best illustrated in FIG. 4). The bristles 12 at this location have now captured any pedicles that extended into the spacing between the bristles whilst still supporting the grapes. The folded belt 10 is then progressively inverted until the grapes 22 fall clear from the belt whilst the pedicles 24 remain trapped and with a moving belt are effectively carried away. A conventional belt 30 then carries the grapes away. Even if the bristles hold a small portion of a pedicel this has been found to be sufficient to capture the pedicle and carry it away by the moving belt.

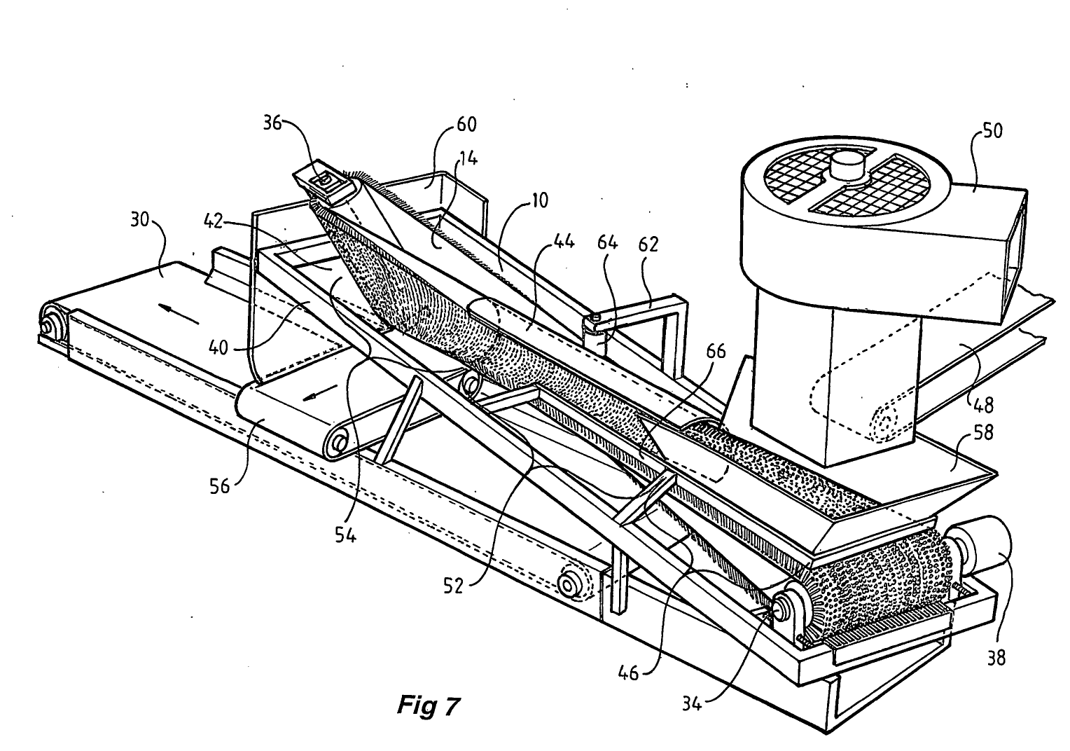

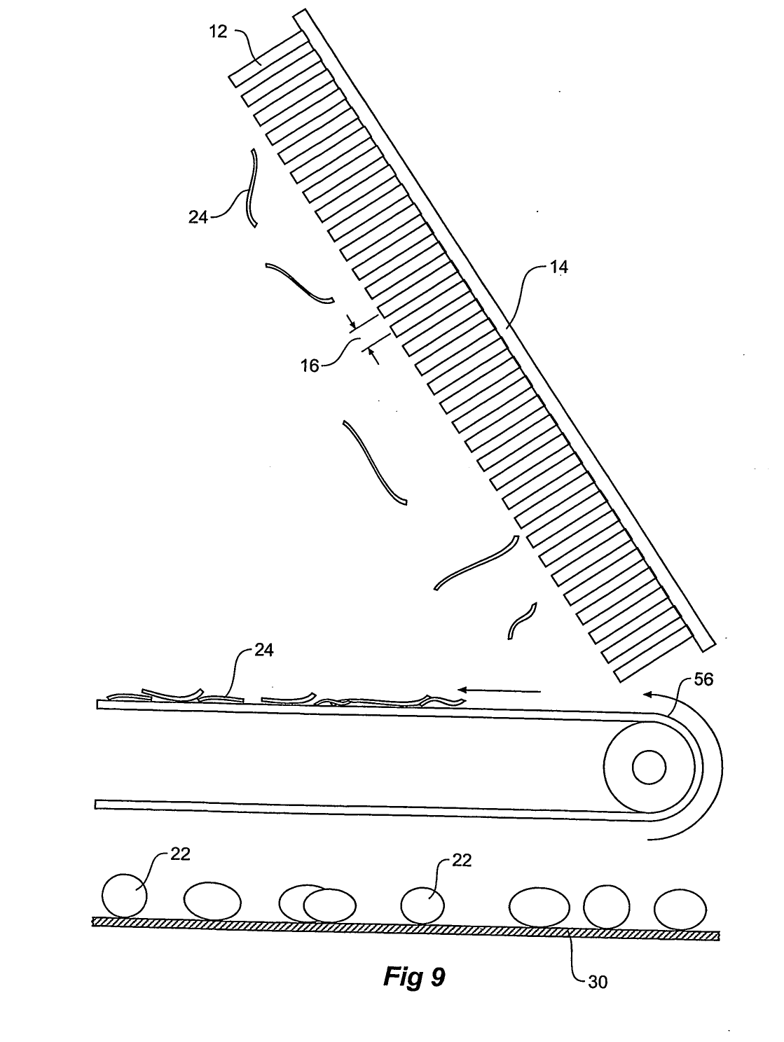

Referring now to FIG. 7 to 9 there is shown the belt, the framework that folds and inverts the belt, and other conveyor belts that than carry away the now separated fruit and pedicles. The reader should understand that the framework as described is but one example and other embodiments may equally well be constructed whilst still falling within the scope of the invention.

Thus there is shown a fruit separation system 32 including belt 10 as already described. The belt is mounted on two opposing rollers 34 and 36, roller 34 typically powered by a conventional motor 38 such as well-known hydraulic motors used in the industry. Both the rollers and the belt are supported within a frame 40 and are adjustable in their relative orientation. Thus wherein roller 34 is generally horizontal or close to it, roller 36 is rotated to such an angle that the upper surface of the belt is rotated through an angle of approximately 135 degrees so that at location 42 the bristles face downwardly at an angle of some 45 degrees. The reader should appreciate that any material, which is being carried by the belt, would fall away from the belt when it is inverted to such an angle.

However, inverting the belt though such an angle does not result in the bristles coming together to capture any pedicles. This is achieved by the use of a guide 44 in the shape of a semi-circular plate whose radius of curvature is chosen so that it forces the belt as it leaves roller 34 to be folded around its longitudinal axis until the bristles effectively are touching and even overlap thus trapping any pedicles. Whilst the belt is passing through the guide, it is inverted sufficiently so that any fruit fall away from the belt. As the belt leaves the guide it unfolds allowing any trapped pedicles to no longer be trapped and because the belt continues to be inverted also fall away from the belt.

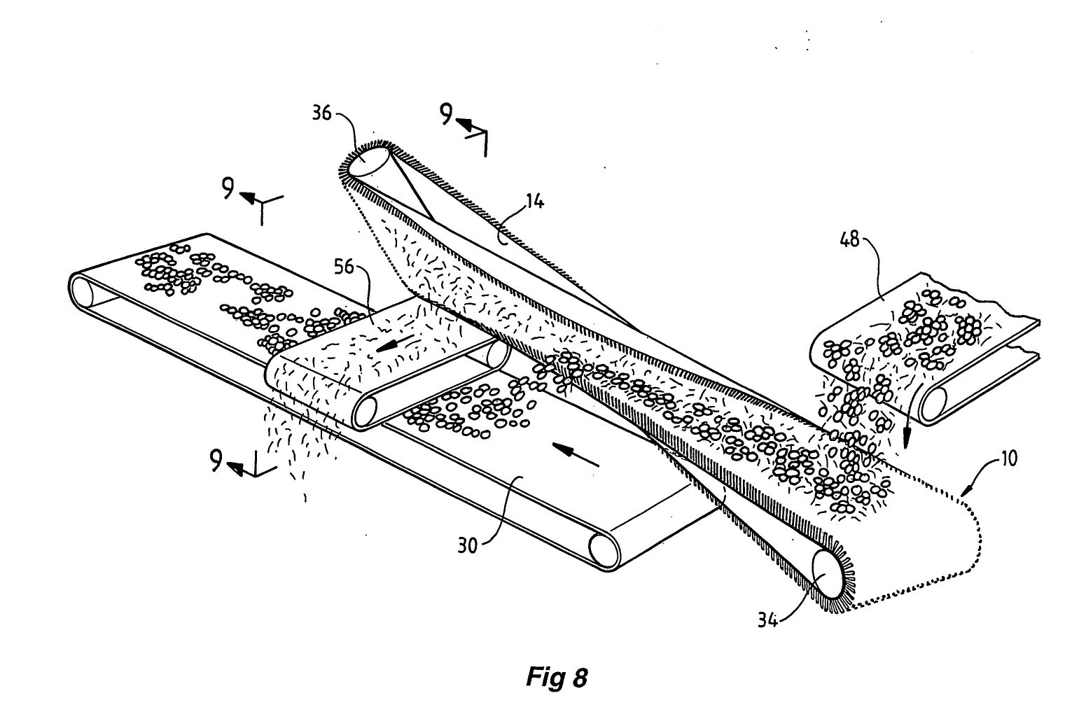

With particular reference to FIGS. 7 and 8, the belt as used in the present invention can thus be seen to have three separate operating sections. The first section 46 is where the harvested grapes and pedicles are dropped onto belt 10 by the use of a first feeder belt 48 with fan 50 also used to remove large unwanted matter such as leaves. The belt 10 then progressively inverts.

In the second section 52 the guide 44 causes the belt 10 to fold around its longitudinal axis, trapping any pedicles that have fallen (or parts thereof) between the bristles 12. Since the belt continues to invert even through the guide 44, the angle of the roller 36 is selected so that during this time the belt has sufficiently inverted to cause any non-trapped material and grapes to fall onto the conveyor belt 30.

In the third section 54 the guide is no longer present and the belt 10 is cause to unfold. As the belt unfolds, the bristles no longer trap and pedicles and because the belt is still inverted and continues to do so fall away from the belt onto a third conveyor belt 56 where they are conveyed either into a collection bin (not shown), or in most cases simply dumped as a grape harvester is moving along a row of vines.

The configurations of the feeder belt 48, conveyor belt 30, and third conveyor belt 56 are to be understood to be well known in the art and it is not intended to discuss those in further detail herein. Thus, as with most belts they are supported by driven rollers that are adjustable to appropriately drive and tension the belt.

Still referring to FIG. 7, the reader should appreciate that the longitudinal axis of the belt 10 and the belt 30 are not parallel and that the belt 10 actually extends at a slight angle to the belt 30. This has been deliberately designed so that the location of the folded belt in section 52 is generally off-centre to the belt 30 so that any falling grapes have sufficient room as they fall and move across the belt. However, this is not intended to be an essential or limiting feature of the present invention.

The present system may also include protective panels or skirts mounted on either end of the belt 10. Thus first skirt 58 ensures that harvested material is fed onto belt 10, whilst skirt 60 ensures that no pedicles fall from belt 10 onto belt 30 and contaminate the now separated fruit.

Other features of the system illustrated in FIG. 7 are of general engineering principles including arm 62 that supports s third roller 64 that ensures that the belt does not rub against the back of guide 44. A rail 66 is also provided alongside belt 10 in the second section 52 that just ensures that any large clusters or bunches of grapes fall onto belt 30.

It is also important to note that the folding or bending of the conveyor belt to configure the apexes responsible for the fixable separation between the first and second material can be achieved by a variety of means. The importance of this invention as described above is to cover embodiments whereby a conveyor belt includes a series of bristles or the like, that support one particular material, while a second material is allowed to fall at least in part within the space provided between such bristles.

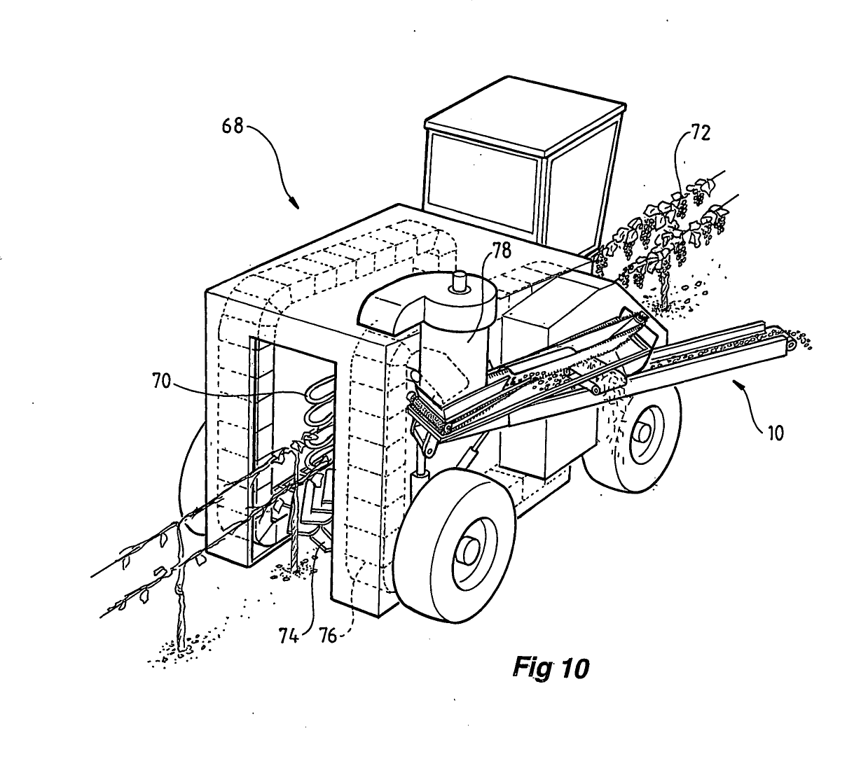

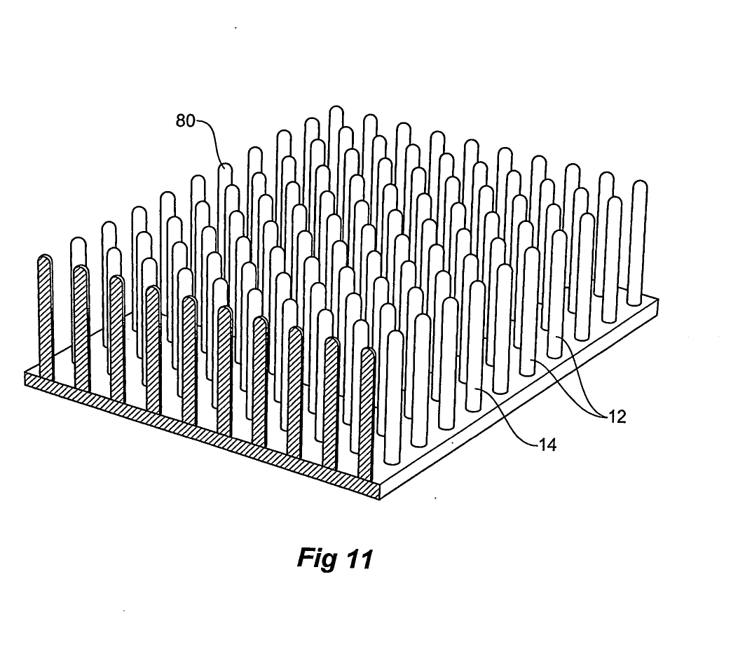

FIG. 10 illustrates the present invention when used with a grape harvester 68. Such grape harvesters are well known and it is not intended to go into a length discussion about them herein. In general a grape harvester includes sets of beaters 70 that shake fruit from vines 72 and that then fall onto a set of plates 74 where they are directed to conveyer system such as a bucket system 76 illustrated. The buckets then convey the harvested material onto a feeder belt 78 and then onto the system as describer earlier. Typically the cleaned grapes are fed into a bin that is driven alongside the grape harvester.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

Thus, in some instances it may be preferably to have the tops of the bristles of a different shape, such as the rounded tops 80 illustrated in FIG. 11. Also the spacing of the bristles may indeed vary is one wants to harvest or clean fruits such as oranges, apples and even stone fruits from other matter such as small branches or leaves. The principle of the invention remains the same.

The separation of the first and second material was caused by inverting the belt so as to cause the non-captured material to fall away due to gravity. The belt is further rotated so that as the pedicles are uncaptured they too fall away. However, other means could be used instead of gravity, for example air fans could be used to blow away pedicels as could a water cleaning system. A water cleaning system would also ensure that the belt itself is kept clean. Other modifications may include a comb located around the first roller to ensure that any material that is trapped within the channels is removed before the belt received new harvested material.

One should also appreciate that changing the dimensions of the belt and the bristles may also be preferred when harvesting other crops.

In any claims that follow and in the summary of the invention, except where the context requires otherwise due to express language or necessary implication, the word “comprising” is used in the sense of “including”, i.e. the features specified may be associated with further features in various embodiments of the invention.

1. A foldable conveyor belt mountable to a conveyor system framework for separating a first from a second material, said second material having at least one dimension smaller than said first material, said belt including;
a base and a series of aligned projections extending along said base, each projection having a free end and adapted to support on top therein said first and second material;
a channel network between said projections of a width equal at least to said one smaller dimension of said second material and smaller than the dimension of said first material to receive at least a portion of only said second material;
whereby said belt is adapted to be inwardly folded when both first and second material is carried thereon, causing corresponding apexes between adjacent aligned projections to approach each other thereby capturing said portion of said second material located within said channel network while still freely supporting said first material.

2. A foldable conveyor belt as in claim 1 wherein said projections are characterized by being a series of selectively spaced bristles.

3. A foldable conveyor belt as in claim 1 wherein said belt is folded around its longitudinal axis until the free ends of adjacent transverse bristles abut each other.

4. A conveyor belt assembly as in claim 1 further including folding means adapted to cause said belt to be folded inwardly along its longitudinal axis.

5. A conveyor belt assembly as in claim 4 wherein said folding means includes a longitudinally arced segment through which is fed said belt such that when said belt is drawn through said segment, the belt folds inwardly into a corresponding arc shape.

6. A foldable conveyor belt assembly as in claim 4 wherein said assembly includes two spatially separated rollers around which is fed said belt, the first of said rollers being in a generally horizontal orientation, the second roller being at a angle substantially different from the horizontal.

7. A foldable conveyor belt as in claim 6 wherein said second roller inverts said belt through an angle greater than some 120 degrees thereby causing the first material to fall away from said belt.

8. A foldable conveyor belt as in claim 6 including at least three operable sections through which said belt is inverted, said first section adapted to enable for the feeding of said first and second material, said second section defined by the arc segment causing said belt to inwardly fold capturing said second material and causing said first material to fall away and said third section during which said belt unfolds causing said second material to fall away from said belt as it is fully inverted.

9. A foldable conveyor belt as in claim 8 wherein the length of the three sections is approximately equal.

10. A foldable conveyor belt assembly as in claim 4 further including a second conveying belt adapted to convey said separated first material away from said conveyor belt.

11. A foldable conveyor belt assembly as in claim 4 further including a third conveying belt adapted to convey away said separated second material.

12. A grape harvesting machine including a foldable belt assembly as claimed in claim 4.
